(19) United States
(12) Patent Application Publication
(10) Pub. No.: US 2009/0061668 A1
(43) Pub. Date: Mar. 5, 2009

(54) Pass-through grounding plug

(76) Inventors: Bruce Douglas Powell, Cary, NC (US); Anthony P. Noto, Knightdale, NC (US)

Correspondence Address: RG & ASSOCIATES, 1103 TWIN CREEKS, STE. 120, ALLEN, TX, 75013, US

(21) Appl. No.: 12/154,272

(22) Filed: May 21, 2008

Related U.S. Application Data
(60) Provisional application No. 60/939,122, filed on May 21, 2007.

(51) Int. Cl. H01R 29/00

(52) U.S. Cl. 439/174

(57) ABSTRACT

An electrical connector and a method of use of the electrical connector during installation of an Optical Network Terminal (ONT). The ONT includes a power supply unit having a pass-through grounding plug. The pass-through grounding plug includes an electrically-conductive grounding prong that is operable to engage a ground conductor of an electrical component. For installation purposes, for example, using existing home wiring, the grounding prong may be retractable, removable and foldable into a body of the plug. When installing the ONT, one would determine whether a power source to which a power supply unit of the ONT is to be connected is within a predetermined distance from an installation location of the ONT. Further, one would determine whether the power source includes a ground conductor. In instances where there is not a ground conductor, the grounding prong may be removed, folded, or retracted into the body of the plug.

### CROSS-REFERENCE TO RELATED APPLICATIONS

This application claims priority to U.S. Provisional Application No. 60/939,122, filed on May 21, 2007, the disclosure of which is incorporated herein in its entirety by reference.

### BACKGROUND OF THE INVENTION

1. Field of the Invention

Methods and apparatuses consistent with the present invention relate to an electrical connector and a method of use thereof during installation of an Optical Network Terminal. More particularly, the electrical connector may be a pass-through grounding plug used with a power supply of the Optical Network Terminal, wherein the pass-through grounding plug includes at least one of a removable, retractable, folding, or breakaway grounding prong to facilitate installation of the Optical Network Terminal.

2. Description of the Related Art

An Optical Network System distributes an optical signal from, for example, a central office over an optical distribution network. At the endpoints of this network, devices such as an Optical Network Terminal convert the optical signal into an electrical signal. The signal usually travels electrically between the Optical Network Terminal and subscriber devices, such as internet and phone systems, and televisions.

The Optical Network Terminal generally requires an earth ground for functional operability. An earth ground may be provided to the Optical Network Terminal by various means, such as driving a separate ground rod into the ground and directly wiring the ground to the Optical Network Terminal; bonding an existing, grounded structure (pipe, conduit, etc.) to the Optical Network Terminal; or connecting the Optical Network Terminal to ground through existing wiring, such as the electrical infrastructure of a home or business. Note that the Optical Network Terminal does not require the ground for safety purposes, but rather for functional and operational purposes.

In the related art, one practice used for grounding the Optical Network Terminal during its installation is to use a National Electrical Manufacturers Association (NEMA) 15 (3-wire) cordset with integral outlet in conjunction with the Optical Network Terminal. The 3-wire cordset is typically provided as part of a kit with the Optical Network Terminal, and is bonded to the Optical Network Terminal's board for grounding purposes. An Optical Network Terminal Power Supply Unit (OPSU) is used to power the Optical Network Terminal and is plugged into the outlet of the provided 3-wire cordset. The OPSU may be double insulated and has a 2-prong (ungrounded) cordset only. Then, the 3-wire cordset may be plugged into the existing electrical infrastructure of the home or business.

There are numerous grounding situations that may occur in the field during installation of the Optical Network Terminal.

In a first installation situation, a subscriber of a voice, video and/or data provider may have a grounded (3-wire) outlet in their existing electrical infrastructure (such as in their home or business) located within a predetermined distance, for example, within ten (10) feet of the installation location of the Optical Network Terminal. This is a situation that allows the provided 3-wire cordset to be plugged directly into the grounded outlet, and the OPSU to be plugged into the 3-wire cordset.

In a second installation situation, there may be a grounded (3-wire) outlet, but the outlet may not be within ten (10) feet of the installation location of the Optical Network Terminal. In this second situation, the OPSU is physically detached from the Optical Network Terminal, and the OPSU is installed within ten (10) feet of the grounded outlet. As a result of this detachment, a separate, low voltage lead is required to be fabricated in the field to join the OPSU to the Optical Network Terminal. Further, since there is no ground connection to the Optical Network Terminal from the existing electrical infrastructure, a separate ground must be run from a ground rod (or similar grounded location) to the board of the Optical Network Terminal for operational purposes. In this second situation, since a low voltage lead must be fabricated and a separate ground run to the Optical Network Terminal, the 3-wire cordset provided with the Optical Network Terminal is not used for installation.

In a third installation situation, there may be a 2-wire (ungrounded) outlet in the existing electrical infrastructure located within ten (10) feet of the installation location of the Optical Network Terminal. Here, the OPSU having the 2-prong (ungrounded) cordset may be plugged directly into the 2-wire outlet. However, since there is no ground connection to the Optical Network Terminal from the existing electrical infrastructure (such as a house mains), a separate ground must again be run from a ground rod (or similar grounded location) to the board of the Optical Network Terminal. Again, in this third situation, the 3-wire cordset provided with the Optical Network Terminal is not used for installation.

In a fourth installation situation, there may be a 2-wire (ungrounded) outlet that is not within ten (10) feet of the installation location of the Optical Network Terminal. Here, the OPSU is physically detached from the Optical Network Terminal and installed within ten (10) feet of the outlet. Like before, when the OPSU is physically detached from the Optical Network Terminal, a separate, low voltage lead is required to be fabricated in the field to join the OPSU to the Optical Network Terminal. Further, since there is not a ground connection to the Optical Network Terminal, for example, from the house mains, a separate ground must be run from a ground rod (or similar grounded location) to the board of the Optical Network Terminal. Like in second and third installation situations, the 3-wire cordset provided with the Optical Network Terminal is not used for installation.

Accordingly, the 3-wire cordset is used in limited installation situations. Providing the 3-wire cordset thus may increase the costs as well as space requirements associated with installation of the Optical Network Terminal.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an electrical connector and a method of use thereof with an Optical Network Terminal.

The present invention also provides an Optical Network System for converting an optical signal into an electrical signal.

Further still, the present invention provides a method for installing an Optical Network Terminal.

According to an aspect of the invention, there is provided an electrical connector comprising: a body including electrically-insulated material; a first electrically-conductive lead secured in the body and extending therefrom, the first electrically-conductive lead operable to engage a hot conductor of an electrical component; a second electrically-conductive lead secured in the body and extending therefrom, the second lead operable to engage a neutral conductor of the electrical component; and an electrically-conductive grounding prong, the electrically-conductive grounding prong operable to engage a ground conductor of the electrical component, wherein the grounding prong is at least one of retractable, removable from, and foldable into the body of the electrical connector.

According to another aspect of the invention, there is provided an Optical Network System, the Optical Network System comprising: an Optical Network Terminal; and a power supply unit that provides power to the Optical Network Terminal, the power supply unit including an electrical connector, the electrical connector comprising: a body including electrically-insulated material; a first electrically-conductive lead secured in the body and extending therefrom, the first electrically-conductive lead operable to engage a hot conductor of an electrical component; a second electrically-conductive lead secured in the body and extending therefrom, the second lead operable to engage a neutral conductor of the electrical component; and an electrically-conductive grounding prong, the electrically-conductive grounding prong operable to engage a ground conductor of the electrical component, wherein the grounding prong is at least one of retractable, removable from, and foldable into the body of the electrical connector.

According to yet another aspect of the invention, there is provided a method for installing an Optical Network Terminal comprising: determining whether a power source is within a predetermined distance from an installation location of the Optical Network Terminal; determining whether the power source to which a power supply unit of the Optical Network Terminal is to be connected includes a ground conductor, the power supply unit including a plug having an electrically-conductive grounding prong; and connecting the power supply unit of the Optical Network Terminal directly to the power source when the power source includes a ground conductor and is within the predetermined distance.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1A illustrates an electrical connector according to an exemplary embodiment of the present invention, wherein the electrical connector includes a grounding prong removable by threaded disengagement with the body of the electrical connector;

FIG. 1B illustrates an electrical connector according to an exemplary embodiment of the present invention, wherein the electrical connector includes a grounding prong removable by breakable disengagement with the body of the electrical connector;

FIG. 1C illustrates an electrical connector according to an exemplary embodiment of the present invention, wherein the electrical connector includes a grounding prong removable by frictional disengagement with the body of the electrical connector;

FIG. 1D illustrates an electrical connector according to an exemplary embodiment of the present invention, wherein the electrical connector includes a grounding prong foldable at least partially into the body of the electrical connector;

FIG. 2 illustrates an Optical Network System according to an exemplary embodiment of the present invention;

FIG. 3 is a flowchart of a method of installation of the Optical Network System.

FIG. 4 illustrates an existing ground path for Optical Network Terminal in accordance with the prior art; and

FIG. 5 illustrates an Earth ground path for Optical Network Terminal in accordance with an exemplary embodiment of the present disclosure.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout.

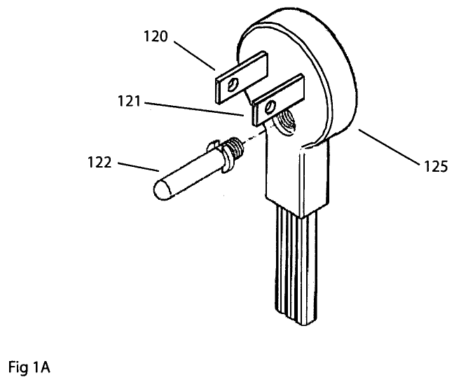

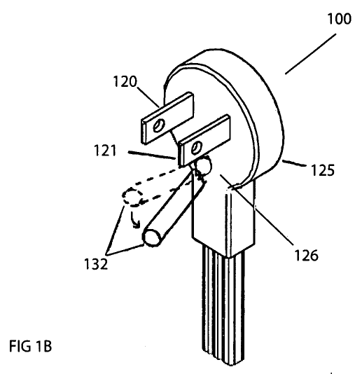

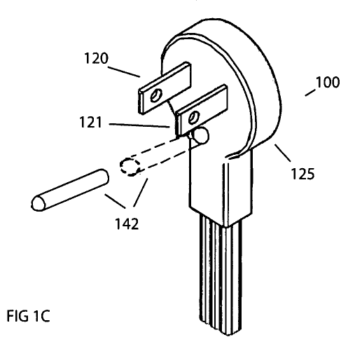

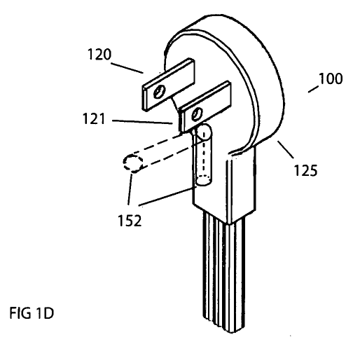

FIG. 1A illustrates an electrical connector 100 according to an exemplary embodiment of the present invention. As shown in FIG. 1A, the electrical connector 100 includes a body 125. The body 125 of the electrical connector 100 may include electrically-insulated material, such as an insulative thermoplastic elastomer (TPE) material.

The electrical connector 100 may also include a first electrically-conductive lead 120 secured in the body 125 and extending therefrom. The first electrically-conductive lead 120 may be operable to engage a hot conductor of an electrical component (not shown). Further, a second electrically-conductive lead 121 may be secured in the body 125 of the electrical connector 100 and extending therefrom. The second lead 121 may be operable to engage a neutral conductor of the electrical component. Electrical components in this case may include, for example, any component that has a pass-through connection, such as an electrical outlet of a home or business.

Also, the electrical connector 100 may include an electrically-conductive grounding prong 122 operable to engage a ground conductor of the electrical component. In the present invention, the grounding prong 122 is at least one of retractable, removable from, and foldable into the body 125 of the electrical connector 100. These retractable, removable, and foldable features of the grounding prong 122 of the electrical connector 100 provide installation flexibility by allowing the electrical connector 100 to be used in situations where the existing electrical infrastructure includes either 2-prong (ungrounded) or 3-prong (grounded) electrical outlets. In the present invention, additional cordsets such as those used in the related art during installation of the Optical Terminal Network may be unnecessary, and accordingly, component and installation costs for components of the cordset such as the cord, an outlet, the associated connectors, a strain relief, and a mounting plate may be eliminated. The present invention may further eliminate the space requirements for these unnecessary components.

In the exemplary embodiment of the present invention shown in FIG. 1A, the grounding prong 122 is removable by threaded disengagement with the body 125 of the electrical connector 100. The threading and disengagement of the grounding prong 122 with the electrical connector 100 may encompass several types of threading generally known to those of ordinary skill in the art, for example, use of helical or tapered structures used to convert between rotational and linear movement or force between the grounding prong 122 and electrical connector 100. In another exemplary embodiment of the invention, the threaded grounding prong 122 may include a provision at one end (such as a slot or crosshead screw provision) to turn the prong 122.

FIG. 1B illustrates an electrical connector 100 according to another exemplary embodiment of the present invention. In FIG. 1B, the electrical connector 100 may include an electrically-conductive grounding prong 132 operable to engage a ground conductor of the electrical component. Grounding prong 132 may be fabricated in a way and from a material such that it can be broken or snapped away from the electrical connector 100 at or near a face 126 of the electrical connector 100. FIG. 1B depicts the grounding prong 132 being removed by breakable disengagement with the body 125 of the electrical connector 100.

FIG. 1C illustrates an electrical connector 100 according to yet another exemplary embodiment of the present invention. In FIG. 1C, the electrical connector 100 may include an electrically-conductive grounding prong 142 operable to engage a ground conductor of the electrical component. Grounding prong 142 may be fabricated in a way, for example, tapered at one end, and from a material such that it engages and disengages with the electrical connector via frictional force. FIG. 1C depicts the grounding prong 142 being removed by frictional disengagement with the body 125 of the electrical connector 100.

FIG. 1D illustrates an electrical connector 100 according to still another exemplary embodiment of the present invention. In FIG. 1D, the electrical connector 100 may include an electrically-conductive grounding prong 152 operable to engage a ground conductor of the electrical component. As shown in FIG. 1D, the grounding prong 152 is foldable at least partially into the body 125 of the electrical connector 100. In another exemplary embodiment, the grounding prong 152 may be retractable by withdrawing into the body 125 of the electrical connector 100.

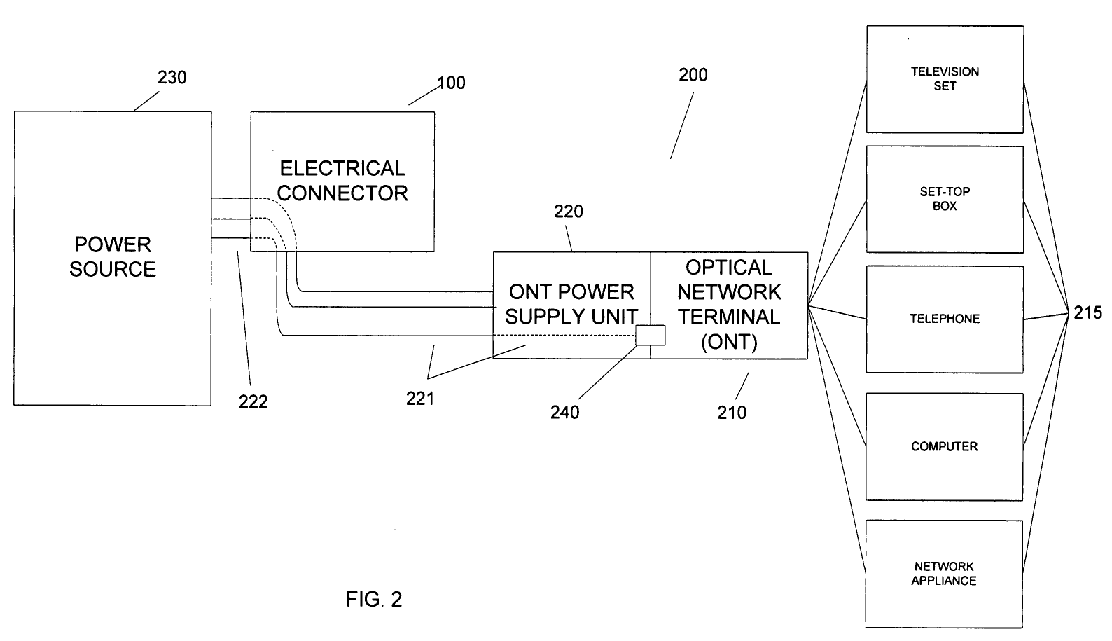

FIG. 2 illustrates an Optical Network System 200 according to an exemplary embodiment of the present invention. In FIG. 2, the Optical Network System 200 includes an Optical Network Terminal 210. The Optical Network Terminal 210 may be connected to one or more customer subscriber devices 215, such as televisions, set-top boxes, telephones, computers, or network appliances, which ultimately receive the voice, video and/or data delivered to the Optical Network Terminal 210.

To provide power to the Optical Network Terminal 210, the Optical Network System 200 may further include a power supply 220 known hereinafter as the ONT Power Supply Unit (OPSU) 220. The OPSU 220 may include a pass-through ground wire 221 and a removable, foldable, or retractable ground prong 222 associated with the electrical connector 100. Embodiments of the ground prong 222 that may be used with the invention may include, for example, the aforementioned ground prongs 122, 132, 142, 152.

The OPSU may be powered, for example, using existing power sources, such as home wiring and associated electrical infrastructure 230. The OPSU 220 may also be provided with a bonding connection 240 to connect the ground to the Optical Network Terminal 210.

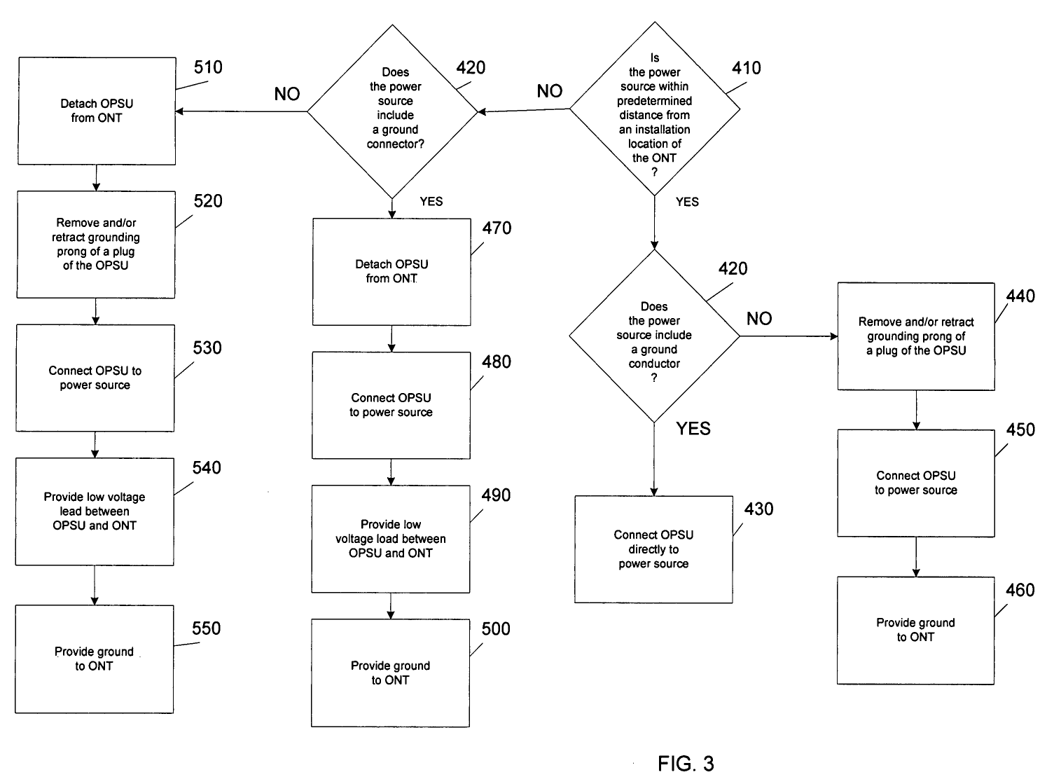

FIG. 3 is a flowchart of an exemplary method of installation of the Optical Network Terminal. In FIG. 3, at least two determinations of installation suitability may be made for installing the Optical Network Terminal. The order of these determinations is interchangeable. In the exemplary embodiment shown in FIG. 3, it is determined 410 whether a power source to which the OPSU is to be connected is within a predetermined distance from an installation location of the Optical Network Terminal. In exemplary embodiments of the invention, the distance may be about 10 feet or less. In another exemplary embodiment, the ONT may be provided with a length (for example, up to 20 feet) of low voltage wiring preinstalled between the OPSU and ONT to facilitate remote mounting of the OPSU.

Further, it is determined 420 whether a power source to which the OPSU is to be connected includes a ground conductor. In the exemplary method, the OPSU may include a plug having an electrically-conductive grounding prong.

In one exemplary embodiment of the method of the invention, when the power source is within the predetermined distance, and includes a ground conductor, for example, a NEMA 15 grounded outlet in the existing home electrical infrastructure, the OPSU may be directly connected 430 to the power source.

In another exemplary embodiment of the method of the invention, when the power source is within the predetermined distance, but does not include the ground conductor, for example, a 2-prong ungrounded outlet, an electrically-conductive grounding prong of a plug of the OPSU may be at least one of removed, folded, and retracted 440 and the OPSU may then be connected 450 to the power source. In this embodiment, a ground may be provided 460 to the Optical Network Terminal.

In yet another exemplary embodiment of the method of the invention, when the power source is not within the predetermined distance, but includes the ground conductor, the OPSU may be detached 470 from the Optical Network Terminal and connected 480 to the power source. In this embodiment, a low voltage lead may be provided 490 between the OPSU and the Optical Network Terminal, and a ground may be provided 500 to the Optical Network Terminal. In certain exemplary embodiments as discussed above having preinstalled low voltage wiring, the low voltage lead may need to be fabricated in the field only if the OPSU is located more than 20 feet from the ONT.

Further still, in an exemplary embodiment of the method of the invention, when the power source is not within the predetermined distance, and further does not include the ground conductor, the OPSU may be detached 510 from the Optical Network Terminal, an electrically-conductive grounding prong of a plug of the OPSU may be at least one of removed, folded, or retracted 520, the OPSU may be connected 530 to the power source, a low voltage lead may be provided 540 between the OPSU and the Optical Network Terminal, and a ground may be provided 550 to the Optical Network Terminal.

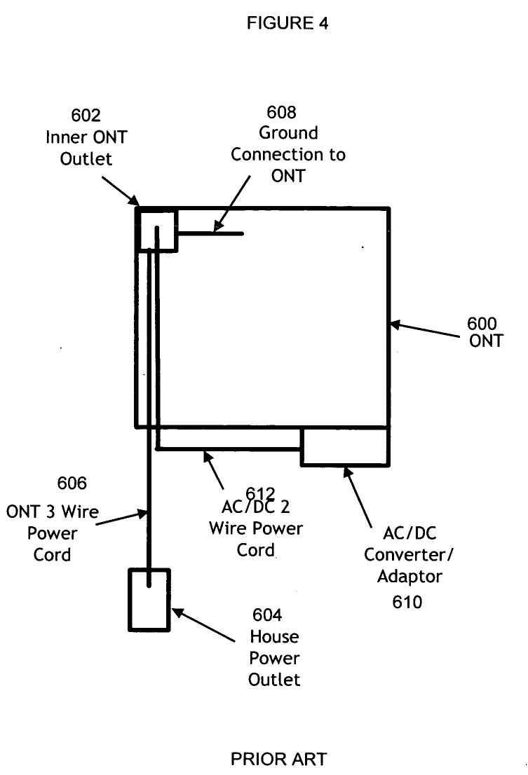

FIG. 4 illustrates an existing ground path for Optical Network Terminal in accordance with the prior art. In current implementation of ONT 600, an inner ONT outlet 602 is provided. In order to provide a ground connection 608 to the ONT 600, a three prong power cord 604 may bring the ground connection from an outlet, such as a house power outlet 604, to the inside of the ONT. The two power leads and the ground lead are terminated to the outlet 602 to supply the AC connection for the power converter. The ground wire then continues from inner ONT outlet 602 and is bonded to the ground plate of the ONT unit 606. After the ground connection is provided to the ONT 600, the AC/DC power adaptor 610 may power the ONT 600 when the adaptor 610 is plugged into the ONT outlet 602.

In cases where the house power outlet 604 is not grounded, or not near an installation site power cord, the AC/DC power adaptor 610 may be plugged directly into a wall outlet (up to 100 feet away). Because the AC/DC adaptor 610 already has a two prong ungrounded wire 612, there is no issue of connecting it where there is no AC main ground or only has a two prong wall outlet. While this approach provides ground protection to ONT 600, it is costly and adds to the size of the ONT assembly.

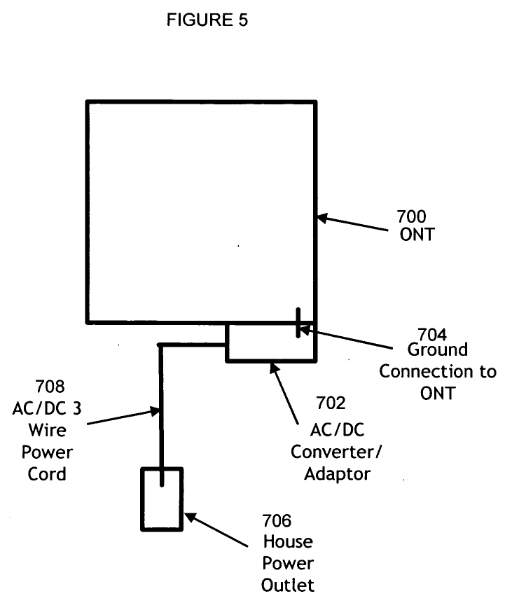

FIG. 5 illustrates an Earth ground path for Optical Network Terminal in accordance with an exemplary embodiment of the present disclosure. A new earth ground path is provided to ONT 700 by the AC/DC power converter/adaptor 702. In one embodiment, the AC/DC power converter/adaptor 702 passes a ground connection to the ONT 700 via a three prong plug, which comprises a positive lead, a negative lead, and a ground lead. The AC/DC power converter/adaptor 702 comprises a connection point 704 for making the ground connection to the ground plate of the ONT 700. In one embodiment, the connection point 704 may be a terminal or a wire connection. To provide the ground connection to the AC/DC power converter/adaptor, the AC/DC three prong wire power cord 708 provides the ground from an outlet, such as house power outlet 706 to the adaptor 702 and terminates at the connection point 704. Because the AC/DC power converter/adaptor 702 is currently a double insulated part that does not require a ground, a new ground connection is added to the adaptor 702 which acts as a pass-through to provide an earth ground to the ONT 700.

By providing a ground connection from the AC/DC power converter/adaptor 702, the heavy power cord 606, inner ONT outlet 602, and the space necessary to house the outlet 602 and to store the AC/DC power cord 612 may be eliminated. These eliminations result in the reduction of overall size of the ONT 700 and costs associated in assembling the ONT 700.

In cases where the house power outlet 706 is not grounded or near an installation site, an additional outside earth ground connection must be provided. However, the AC/DC power converter adaptor 702 may still be used to provide power and ground connection to the ONT. In cases where the house power outlet 706 only has a two prong outlet, the electronic connector illustrated in FIGS. 1A to 1D may be used to provide a ground connection to the AC/DC adaptor 702. In that case, the AC/DC wire power cord 708 may be removable or interchangeable to a three wire grounded cordset in order to utilize the passthrough ground connection from the outside ground outlet. Alternatively, the AC/DC wire power cord 708 may be removable or interchangeable with a two wire cordset that will meet code standard if the house main ground is not available.

It is noted that none of the exemplary embodiments of the present invention described above require additional cordsets such as those used in the related art during installation of the Optical Network Terminal.

Although a few exemplary embodiments of the present invention have been shown and described, the present invention is not limited to the described exemplary embodiments. Instead, it would be understood by those skilled in the art that changes may be made to these exemplary embodiments without departing from the principles and spirit of the invention, the scope of which is defined by the claims and their equivalents.

What is claimed is:

1. An electrical connector comprising:
a body including electrically-insulated material;
a first electrically-conductive lead secured in the body and extending therefrom, the first electrically-conductive lead operable to engage a hot conductor of an electrical component;
a second electrically-conductive lead secured in the body and extending therefrom, the second lead operable to engage a neutral conductor of the electrical component; and
an electrically-conductive grounding prong, the electrically-conductive grounding prong operable to engage a ground conductor of the electrical component, wherein the grounding prong is at least one of retractable, removable from, and foldable into the body of the electrical connector.

2. The electrical connector according to claim 1, wherein the grounding prong is removable by threaded disengagement with the body.

3. The electrical connector according to claim 1, wherein the grounding prong is removable by breakable disengagement with the body.

4. The electrical connector according to claim 1, wherein the grounding prong is removable by frictional disengagement with the body.

5. The electrical connector according to claim 1, wherein the grounding prong is foldable at least partially into the body of the electrical connector.

6. An Optical Network System comprising:
an Optical Network Terminal; and
a power supply unit that provides power to the Optical Network Terminal, the power supply unit including an electrical connector, the electrical connector comprising:
a body including electrically-insulated material;
a first electrically-conductive lead secured in the body and extending therefrom, the first electrically-conductive lead operable to engage a hot conductor of an electrical component;
a second electrically-conductive lead secured in the body and extending therefrom, the second lead operable to engage a neutral conductor of the electrical component; and
an electrically-conductive grounding prong, the electrically-conductive grounding prong operable to engage a ground conductor of the electrical component, wherein the grounding prong is at least one of retractable, removable from, and foldable into the body of the electrical connector.

7. The Optical Network System according to claim 6, wherein the grounding prong is removable by threaded disengagement with the body.

8. The Optical Network System according to claim 6, wherein the grounding prong is removable by breakable disengagement with the body.

9. The Optical Network System according to claim 6, wherein the grounding prong is removable by frictional disengagement with the body.

10. The Optical Network System according to claim 6, wherein the grounding prong is foldable at least partially into the body of the electrical connector.

11. The Optical Network System according to claim 6, wherein the power supply unit includes a bonding connection with the Optical Network Terminal and through which bonding connection the Optical Network Terminal is grounded.

12. A method for installing an Optical Network Terminal (ONT) comprising:
determining whether a power source is within a predetermined distance from an installation location of the ONT;
determining whether the power source to which a power supply unit of the ONT is to be connected includes a ground conductor, the power supply unit including a plug having an electrically-conductive grounding prong; and
connecting the power supply unit of the ONT directly to the power source when the power source is within the predetermined distance and includes a ground conductor.

13. The method for installing an ONT according to claim 12, wherein when the power source is within the predetermined distance, but does not include the ground conductor, at least one of removing, folding, and retracting the electrically-conductive grounding prong of the plug of the power supply unit, connecting the power supply unit of the ONT to the power source, and providing a ground to the ONT.

14. The method for installing an ONT according to claim 12, wherein when the power source is not within the predetermined distance, but includes the ground conductor, detaching the power supply unit from the ONT, connecting the power supply unit to the power source, providing a low voltage lead between the power supply unit and the ONT, and providing a ground to the ONT.

15. The method for installing an ONT according to claim 12, wherein when the power source is not within the predetermined distance and does not include the ground conductor, detaching the power supply unit from the ONT, at least one of removing, folding, and retracting the electrically-conductive grounding prong of the plug of the power supply unit, connecting the power supply unit to the power source, providing a low voltage lead between the power supply unit and the ONT, and providing a ground to the ONT.

16. The method for installing an ONT according to claim 12, wherein the predetermined distance is about 10 feet.

17. The method for installing an ONT according to claim 12, further comprising grounding the ONT through a bonding lead with the power supply unit.

18. The method for installing an ONT according to claim 13, wherein the grounding prong is removable by at least one of threaded, breakable, and frictional disengagement with a body of the plug.

19. The method for installing an ONT according to claim 13, wherein the grounding prong is foldable at least partially into a body of the plug.

20. The method for installing an ONT according to claim 15, wherein the grounding prong is removable by at least one of threaded, breakable, and frictional disengagement with a body of the plug.
